(19) United States
(12) Patent Application Publication
(10) Pub. No.: US 2014/0263192 A1
(43) Pub. Date: Sep. 18, 2014

(54) SHIELDING CUP FOR ORBITAL WELDING

(71) Applicant: LINCOLN GLOBAL, INC., City of Industry, CA (US)

(72) Inventor: Victor Miller, Jamul, CA (US)

(73) Assignee: LINCOLN GLOBAL, INC., City of Industry, CA (US)

(21) Appl. No.: 13/830,868

(22) Filed: Mar. 14, 2013

(51) Int. Cl. B23K 9/32; B23K 9/167

(52) U.S. Cl. CPC B23K 9/325; B23K 9/167
USPC 219/75; 219/74

(57) ABSTRACT

A shielding cup used in connection with a welding torch having a torch head that defines gas outlets for supplying an inert gas to an electrode, the shielding cup including an attachment portion adapted to attach to the torch head; and a nozzle portion extending downward from the attachment portion, wherein the nozzle portion has a depth adapted to be received within the groove and defines an enclosed volume substantially surrounding the electrode, the nozzle portion being open at an outward end, wherein the nozzle portion is adapted to channel the inert gas from the torch head within the volume defined by the nozzle portion.

### TECHNICAL FIELD

In general, the present invention relates to a shielding cup used in connection with orbital welding in a deep groove. More particularly, the present invention relates to a shielding cup having a narrow extended nozzle adapted to the deep groove and provide shielding gas to the electrode and the weld zone.

### SUMMARY OF THE INVENTION

The invention generally provides a shielding cup used in connection with a welding torch having a torch head that defines gas outlets for supplying an inert gas to an electrode and a weld zone, the shielding cup including an attachment portion adapted to attach to the torch head; and a nozzle portion extending downward from the attachment portion, the nozzle portion defining a narrow volume substantially surrounding the electrode, the nozzle portion being open at an outward end, wherein the nozzle portion is adapted to channel the inert gas from the torch head within the volume defined by the nozzle portion.

### DETAILED DESCRIPTION OF THE DRAWINGS

FIG. 1 is a front perspective view of a shielding cup according to the invention.

FIG. 2 is a rear perspective view thereof.

FIG. 3 is a top plan view thereof.

FIG. 4 is a front view thereof.

FIG. 5 is a left side view thereof.

FIG. 6 is a bottom plan view thereof.

FIG. 7 is a partially sectional side elevational view as might be seen along line Y-Y in FIG. 5 showing attachment of the shielding cup to a welding torch.

FIG. 8 is a sectional view similar to FIG. 7 as might be seen along line X-X in FIG. 4.

FIG. 9 is a front elevational view of an orbital TIG welder having a shielding cup according to the invention mounted thereon.

FIG. 9A is a side elevational view of an orbital TIG welder having a shielding cup according to the invention mounted thereon.

FIG. 10 is a front view of an alternate embodiment of a shielding cup having a concave end.

FIG. 11 is a front view of an alternate embodiment of a shielding cup having an angled end.

FIG. 12 is a front view showing a shielding cup kit according to the invention, including interchangeable shielding cups of different lengths for use during different portions of welding a deep groove joint.

### DETAILED DESCRIPTION OF THE INVENTION

When welding thick plates or heavy wall pipes, the weld joint design typically provides a narrow groove to permit an elongated electrode to be placed in the joint with some adjustment of the torch angle to assure a good weld created by layering a series of weld beads upon each other until the joint is filled. This process may be referred to as narrow groove welding or deep groove welding interchangeably throughout the following description. Narrow groove welding is a process where successive single bead weld layers are applied on top of one another in a narrow groove or joint. One of the considerations in the narrow groove environment is maintaining sufficient shield gas to protect the molten weld puddle from atmospheric contamination. Typically, an inert shield gas, such as argon, is provided from outside the weld joint with a long electrode extending into the groove below the shield gas supply.

When performing deep groove pipe welding, it becomes difficult to maintain sufficient gas flow when welding at the 6 o'clock position on the pipe, because the shield gas is being directed upward. Also, when welding in a deep groove, a chimney effect may cause air flow created by a stacking effect or convection current created by the thermal input of the weld torch or from the workpiece, which may be pre-heated, to blow shield gas away from the electrode. To compensate for these disruptions in the shield gas, larger amounts of shield gas may be delivered to the weld joint to maintain the proper environment for the weld puddle.

According to one aspect of the invention, a shielding cup, generally indicated by the number 10, includes an attachment portion, generally indicated by the number 12, and a nozzle portion, generally indicated by the number 20, that at least partially enters the groove G. Shielding cup 10 may be used in connection with an orbital TIG welder to apply a deep groove weld for thick walled pipe as one example. It will be appreciated that the shielding cup 10 of the present invention may be used in connection with other welding processes including submerged arc welding, MIG welding, and MAG welding. In general, the shielding cup 10 may be used in connection with any where shield gas is used. While the present invention will be described with reference to an orbital welder used to apply a weld to a thick walled pipe P requiring a deep groove weld, other geometries forming a deep groove may also be served by use of the shielding cup described herein. Therefore, reference to a deep groove or groove herein should not be read as limiting the invention to a particular welding application.

With reference to FIG. 9, a shielding cup 10 according to the present invention is shown mounted on a welding system, generally indicated by the number 100, used in deep groove welding. In the example shown, welding system 100 includes an orbital TIG welder having a welder body or chassis 101, which may be attached to the work piece or supported on a track. Welder 100 includes a welding torch, generally indicated at 30, having a welding electrode for depositing weld material to form a weld joint. The welder may include a wire feeder connected to a supply of welding wire, such as a spool 103 that provides tungsten wire W to a wire guide 104. In the example shown, a pair of extended wire guides 104 are provided and fed by independent spools 103 located on either side of chassis 101. The extended wire guides 104 are supported on brackets 105 that are laterally outward of electrode and above the workpiece or pipe P. The wire guides extend inward and downward toward electrode 32. The example welder is supported on a track and drive by a tractor drive around pipe with wire guides 104 being located in lead and lag positions relative to welding electrode 30.

Electrode 32 is an extended electrode having an electrode length Lₑ suitable for the groove G being welded. Extended electrode 32 may have any length suitable for a given deep groove weld, including lengths greater than 10 millimeters. As depicted in the example shown, electrode length may be greater than 100 millimeters. The particular example shown has a length of about 120 millimeters. This example is not limiting as electrodes having greater or lesser lengths may be used depending on the depth of the groove G.

Welding torch 30 is connected to a shield gas supply 106, that provides an inert gas, such as argon gas, to welding torch 30. Welding gas supply 106 may include a container, such as a cylinder, that stores shield gas under pressure, and delivery of the shield gas, via appropriate tubing or other conduits, may be controlled by a regulator or other controller 107. A non-pressurized source may be used also with gas delivery provided by a pump or the like.

With reference to FIGS. 7 and 8, welding torch 30 includes gas outlets 34 connected to the shield gas supply to direct shield gas toward electrode 32. In the example shown, gas outlets 34 are provided in a torch head 36. It is contemplated that the electrode 32 may be consumable and the torch head 36 removable to facilitate periodic replacement of the electrode 32. With respect to the gas supply, torch head 36 may include a centrally mounted electrode 32 and include a gas passageway 38 formed in torch head 36 with gas outlets 34 extending radially outward about the perimeter of torch head 36. In the example shown, torch head 36 has a cylindrical collette defining a recessed annular space 39 between an upper lip 41 and lower lip 42. The gas outlets 34 open into the space 39 between rings 41, 42.

An adapter plate or diffuser 40 may supported by torch head 36 below gas outlets 34. In the example shown, diffuser 40 is mounted on a boss extending downward from torch head 36, spacing the diffuser from lower lip 42. Additional spacers may be provided to further space the diffuser as needed. Diffuser 40 may have a variety of forms and geometries including screens, perforated plates, baffles, or other structures for diffusing the flow of gas exiting gas outlets 34. In the example shown, a tungsten adapter having a pair of perforated plates sandwiching a screen is used. Plate has a circular cross-section sized to closely match the diameter and shape of lower lip 42. The torch head 36 may be a commercially available torch head. For example, CK Worldwide offers a suitable torch head under the brand name Gas Saver™.

A sealing member 50 is provided above gas outlets 34 on torch head 36 above upper lip 41 to act as a seal and attach the shielding cup 10 as described more completely below. Sealing member may be an o-ring, as shown, or other suitable gasket. Sealing member 50 may be constructed of any suitable material including but not limited to silicone. In the example shown, a high temperature silicone material was selected. The perimeter 51 of gasket 50 is slightly larger than the perimeter 31 of torch head to facilitate attachment of shielding cup 10 and formation of a seal between torch head 36 and shielding cup 10.

Shielding cup 10 includes a nozzle portion 20 and, in general, is adapted to be attached to torch head 36 so that at least a portion of electrode 32 extends through and resides within nozzle portion 20. Attachment of nozzle portion 20 to torch head 36 may occur in any known manner including but not limited to mechanical fasteners, adhesives, springs, clips, or custom fixtures. In the example shown, shielding cup includes an attachment portion 15 adapted to fasten shielding cup 10 to welding torch 30. Attachment portion 15 is shaped and sized to fit over a generally cylindrical torch head 36. It will be appreciated that the example shown is not limiting and the welding torch 30 and/or torch head 36 may have a variety of shapes and configurations depending upon the manufacturer or type of welding to be performed.

Attachment portion 15 includes an interior wall 17 that generally conforms to torch head 36 and defines a cylindrical opening, generally indicated at 16. One end of cylindrical opening opens outward of shielding cup 10 to receive torch head 36. The opposite end of opening 16 opens into nozzle portion 20 and, thus, is in fluid communication with nozzle portion 20. Opening 16 and is closely sized to the diameter of torch head 36. A sealing member 50, described more completely below, may be provided on torch head 36 above gas outlet 34. The opening 16 is smaller in dimension than perimeter 51 of sealing member 50 to form an interference fit therewith that attaches shielding cup 10 to torch head 36. This fit also seals the upper opening of attachment portion 15 so that shielding gas is directed outward from attachment portion 15 into nozzle portion 20.

To reduce heat and electrical transfer or other electrical magnetic inferences on the arc, an insulator 18 may be provided within attachment portion 17 as shown. Insulator 18 may be constructed of an insulated material or shielded material including a transparent glass or ceramic material, for example Pyrex®, to insulate the torch head 36. Insulator 18 extends downwardly a sufficient length to encompass the diffuser 40 as well. It will be appreciated that when an insulator 18 is housed within attachment portion 15, attachment portion 15 may have a diameter greater than torch head 36 to accommodate the insulator 18.

Since the insulator 18 may be fragile, wall 17 of attachment portion 15 may be constructed of a more resilient material or a sacrificial material that may be replaced and the insulator reused. Suitable materials include but are not limited to metals, such as, steel, stainless steel, brass, copper, and aluminum; high temperature plastics or fiber reinforced materials; ceramics; or combinations thereof. Various coatings or surface treatments may be used to adapt materials for the high temperatures and electrically insulate the nozzle 20 from electrode 32 and the pipe P being welded. Nozzle portion 20 may be made of the same material as attachment portion 15 and formed as an integral piece. In the example shown, attachment portion 15 and nozzle portion 20 are formed as a single piece from stainless steel with a ceramic coating.

When an insulator 18 is used, it may be formed as an integral part of shielding cup 10 or separately attached. In the example shown, insulator 18 is attached to wall 17 by a high temperature silicone adhesive 23. It will be appreciated that other forms of attachment including mechanical fasteners and the like may be used depending upon the type of material used as an insulator 18. Likewise, other high temperature adhesives may be suitable in place of silicone.

In the example shown, insulator 18 defines the cylindrical opening 16 and the interference fit and sealing engagement used to attach sealing cup 10 to torch head 36 is between insulator 18 and sealing member 50.

Nozzle portion 20 extends outward from attachment portion 15, and is adapted to fit within the deep groove. When, as shown, torch head 36 has a different geometry than the geometry required for nozzle portion 20, shielding cup 10 includes a transition portion 22 between attachment portion 15 and nozzle portion 20 to account for the different geometries. As best seen in FIG. 8, transition portion 22 may neck inward from the cylindrical attachment portion 15 toward a narrow elongated nozzle portion 20 that extends into groove G. In the example shown, transition portion 22 necks inward at the front and rear as it extends downward from attachment portion 15. Once a sufficient depth D or thickness of nozzle portion 20 is achieved to permit insertion of nozzle portion 20 within groove G, the front and rear walls 26,27 of nozzle portion 20 may extend downward with equal spacing. Alternatively, as shown, front and rear walls 26, 27 may continue to taper inward toward each other resulting in a smaller depth Dₜ at the tip of nozzle portion 20. This inward taper may be used to match the geometry of groove G or to accelerate the shield gas flow. It will be appreciated that the entire nozzle portion 20 may not be inserted into groove G, and, therefore, the depth D at the upper end 25 of nozzle portion 20 may not be less than the depth D_{g} of groove G. For example, as best seen in FIG. 9A, only the tip of nozzle portion 20 may need to be inserted into groove G. In this example, depth Dₜ at the tip or end of nozzle portion 20 is less than depth D_{g} of groove G.

In the lateral sense, nozzle portion 20 may have any shape. In the example shown, nozzle portion expands outward laterally as it extends downward forming shoulders 28 below attachment portion 15 at transition portion 22. At the end of transition portion 22, the width W of nozzle portion 20 is greater than depth D. In the example shown, width W at this section is about four times greater than depth D, however, this example should not be considered limiting. Sidewalls 29 of nozzle portion 20 may be straight or as shown continue to flare outward from transition 22 resulting in a greater width Wₜ at the tip of nozzle portion 20. In the example shown, sidewalls 29 flare outward at a less rate than transition portion 22. While the transition portion 22 and nozzle portion 20 are shown with linearly inclined surfaces, it will be appreciated that curved surfaces may be used to equal effect.

As best shown in FIGS. 7-8, electrode 32 may be centered within the volume 55, defined by nozzle portion 20. In the example shown, the nozzle portion 20 has a generally rectangular cross section with rounded sidewalls 29. Other cross sections may be used to the same effect, including, but not limited to, oval cross sections, rectangular cross section, a dog bone cross sections, or other generally narrow cross section. In the example shown in FIGS. 1-9, the nozzle portion 20 terminates in a horizontal edge 56. The edge 56 may, however, have a variety of shapes and be customized to the type of joint being welded. For example, for a pipe welding operation, it may be advantageous to have a concave edge 58, as shown in FIG. 10, or an edge 60 that extends at an angle, as shown in FIG. 11. In addition, the length L of cup 10 may be varied by varying the length Lₙ of the nozzle portion 20 may be varied depending on the depth of the groove and the length of electrode 32.

In accordance with another aspect of the invention, a collar 75 may be provided to slip over electrode 32 to help prevent inadvertent contact between nozzle portion 20 and electrode 32. Collar 75 may have any suitable configuration including but not limited to a cylindrical tubular configuration, as shown in FIG. 7. There, collar 75 includes a cylindrical wall defining a hollow bore 76 in which the electrode 32 is received. Bore 76 may be sized to facilitate an interference fit between electrode 32 and collar 75. Alternatively, collar 75 may have an outer dimension that causes it to engage the walls 26,27 of nozzle portion 20 and hold it on electrode 32. In the example shown, collar 75 is slid on to electrode 32 before shielding cup 10 is attached. The attachment portion 15 of shielding cup and upper end 25 of nozzle portion 20 fit over collar 75. The inward taper of walls 26,27 eventually cause nozzle 20 to engage collar 75 (FIG. 8) and hold collar in a central axial position relative to nozzle portion 20. Collar 75 is made of an insulative material including but not limited to a ceramic material.

In accordance with another aspect of the invention, a kit of interchangeable shielding cups 10 is contemplated to adapt the shielding cup 10 during the welding process. For example, when performing a deep groove weld, as weld material is built up within the groove, progressively shorter nozzle portions 20 may be provided to accommodate the additional weld material. For example, the nozzle portion may have a length that varies between 1 centimeter to 10 centimeters by providing plural welding cups 10 having nozzle portions of different lengths within this range. This range is merely an example, and it is contemplated that lengths greater than 10 centimeters may be necessary for a particular deep groove application and lengths less than 1 centimeter may be used toward the end of the weld sequence. In one example, shielding cup kit, generally indicated by the number 110, a first shielding cup 111 has a first nozzle portion 121 having a length Lₙ1. The length of first nozzle portion 121 and the overall length of shielding cup 111 will depend on the depth of groove G. In the example shown, first cup 111 had an overall length of about 4.6 inches or 111 millimeters, and the first nozzle portion 121 had a length of about 3.2 inches or 80 millimeters used during the initial portion of the welding sequence. This shielding cup 111 may be removed and interchanged with a second shielding cup 112 having a second nozzle portion 122 shorter than the length of first nozzle portion 121. While the length of the attachment portion 115 and transition portion 122 were kept constant across the three cups 111,112,113 shown, it will be appreciated that the length of attachment portion may also vary. In the example shown, second cup has an overall length of about 3.6 inches or 90 millimeters with a second nozzle portion 122 having a length of about 2.4 inches or 60 millimeters for the middle portion of the welding sequence where some material has been built up in groove G. Toward the end of the welding sequence, the second shielding cup 112 may be interchanged with a third shielding cup 113 having a nozzle portion 123 having a length shorter than nozzle portions 121,122 of first cup 111 and second cup 112. In the example shown, the overall length of third cup 113 was about 2.2 inches or 55 millimeters with a third nozzle portion having a length of about 1 inch or 25 millimeters. The term about as used in connection with the above example indicates a variation of +/−⅛ of an inch or 3.175 millimeters. By using kit 110, the operator may quickly change between nozzles to adjust the length of the nozzle portion to account for the amount of material built up in the deep groove G. Alternatively, similar kits may be provided with different edges 56 for a particular welding work piece. The kit may be customized depending on the customer's application or a kit including commonly used edge features such as a kit containing a concave edge (FIG. 10), an angled edge (FIG. 11), and a horizontal or straight edge (FIG. 4). It will be appreciated that the attachment portion of each of the nozzles within the kit 110 may be constructed as described in the earlier embodiment to fit a particular welding torch. The ability to quickly interchange shielding cups may be facilitated by using the gasket attachment described above, but it is contemplated that other forms of attachment may be used including but not limited to clamps, springs, mechanical fasteners, tape, and custom fixtures.

By providing a shielding cup 10 according to the invention having a narrow nozzle portion 20 that extends downwardly below diffuser 40, the shielding gas S is limited to a confined volume 55 (FIG. 7). This improves the concentration of shielding gas S around the electrode and in the welding zone Z (FIG. 9) when performing orbital deep groove welding requiring less shielding gas when in the 6 o'clock position by better containing the gas around the electrode and accelerating the gas through a narrow area. Likewise, the nozzle portion better contains the shielding gas S around the electrode 32 and in welding zone Z when the electrode is subjected to convection currents or other air currents created by a chimney effect.

The above examples are merely illustrative of several possible embodiments of various aspects of the present invention, wherein equivalent alterations and/or modifications will occur to others skilled in the art upon reading and understanding this specification and the attached drawings. With particular regard to the various function performed by the above-described components (assemblies, devices, systems, and the like), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the same function in the illustrated implementations of the invention. In addition, although a particular feature of the invention may have been disclosed with respect to only one of several implementations, such feature may be combined with one or more other features of the other implementations as may be desired and advantageous for any given or particular application. Also, to the extent that the terms including, includes, having, has, with, or variance thereof are used in the detailed description and/or in the claims, such terms are intended to be inclusion in a manner similar to the term comprising.

The written description provided above uses examples to disclose the invention, including the best mode, and also to enable one of ordinary skill in the art to practice the invention, including making and using any devices or systems and performing any incorporated methods. The scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literally disclosed structures.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon reading and understanding this specification. It is intended to include all such modifications and alterations insofar as they come within the scope of the appended claims or equivalents thereof.

1. A shielding cup for welding in a deep groove used in connection with a welding torch having a torch head that defines gas outlets for supplying an inert gas to an electrode, the shielding cup comprising:
a nozzle portion in fluid communication with the gas outlets, the nozzle portion extending outward from the attachment portion;
wherein the nozzle portion has a depth adapted to be received within the groove and defines a volume surrounding a portion of the electrode, wherein the nozzle portion is open at an outward end and terminates in an outward edge,
whereby the nozzle portion is adapted to channel the inert gas from the torch head through the volume and out the outward end.

2. The shielding cup of claim 1, wherein the nozzle portion has a rectangular cross section having a width greater than a depth thereof.

3. The shielding cup of claim 1, wherein the nozzle portion has a front wall and a rear wall that extend inward as they extend outward toward the outward edge.

4. The shielding cup of claim 1, wherein the nozzle portion has a pair of sidewalls, wherein the sidewalls extend inward as the extend outward toward the outward edge.

5. The shielding cup of claim 1, wherein the nozzle portion terminates in an edge, wherein the edge is a straight edge.

6. The shielding cup of claim 1, wherein the outward edge is concave in a lateral direction.

7. The shielding cup of claim 1, wherein the outward edge extends at an angle from one lateral side to another lateral side of the nozzle portion.

8. The shielding cup of claim 1, wherein the nozzle portion has a length greater than about 25 millimeters.

9. The shielding cup of claim 1, wherein the nozzle portion has a length of about 80 millimeters.

10. The shielding cup of claim 1, wherein the nozzle portion has a length of about 60 millimeters.

11. The shielding cup of claim 1, wherein the nozzle portion has a length of about 25 millimeters.

12. The shielding cup of claim 1 further comprising an attachment portion adapted to attach to the nozzle portion to the torch head.

13. The shielding cup of claim 11, wherein the attachment portion includes an insulator defining an opening adapted to receive the torch head therein, the insulator being engageable with a sealing member on the torch head to attach the nozzle portion to the torch head, wherein the nozzle portion extends from the attachment portion below the insulator and is in fluid communication with the opening.

14. The shielding cup of claim 11 further comprising a gasket attachable to the torch head, wherein the attachment portion defines an opening adapted to fit over and sealingly engage the gasket and form an interference fit to attach the shielding cup to the torch head.

15. The shielding cup of claim 12 further comprising a transition portion between the attachment portion and the nozzle portion, wherein the transition portion is in fluid communication with the attachment portion and the nozzle portion, wherein the transition portion necks inward toward the attain the depth of the nozzle portion where it joins nozzle portion.

16. A welding system comprising:
a welder including a chassis supporting a welding torch, the welding torch including a torch head;
the torch head defining at least one gas outlet in communication with a gas supply;
an extended electrode supported on the torch head and extending outward relative to the gas outlet;
a shielding cup having an attachment portion adapted to attach to the torch head and a nozzle portion in fluid communication with the gas outlet, the nozzle portion extending outward from the attachment portion;
wherein the nozzle portion has a depth adapted to be received within the groove and defines an enclosed volume surrounding a portion of the extended electrode,
wherein the nozzle portion is open at an outward end and terminates in an outward edge.

17. The welding system of claim 15 further comprising a gasket supported on the torch head inward of the extended electrode and the gas outlet, wherein the attachment portion defines an opening adapted to receive and form an interference fit with the gasket, the gasket sealingly engaging the attachment portion.

18. The welding system of claim 15 further comprising a diffuser between the gas outlet and the nozzle portion.

19. The welding system of claim 15 wherein the nozzle portion has a length greater than 25 millimeters.

20. The welding system of claim 15, wherein the welder is an orbital welder.

21. The welding system of claim 19 further comprising a wire feeder and spool supported on the chassis and adapted to supply a tungsten wire adjacent to the electrode.

22. A deep groove shielding cup kit for a welder having a torch head having an electrode extending outward therefrom and a gas outlet supplying a shielding gas toward the electrode, the kit comprising:
a first shielding cup attachable to the welder and having a first nozzle portion adapted to receive the electrode therethrough, the first nozzle portion extending a first length and terminating in an open end;
a second shielding cup attachable to the welder and having a second nozzle portion adapted to receive the electrode therethrough, the second nozzle portion extending a second length and terminating in an open end, wherein the second length is shorter than the first length.

23. The deep groove shielding cup kit of claim 21 further comprising a third shielding cup attachable to the welder having a third nozzle portion adapted to receive the electrode therethrough, the third nozzle portion extending a third length and terminating in an open end, wherein the third length is shorter than the second length.

24. The welding kit of claim 21, wherein the first length is about 80 millimeters.

25. The welding kit of claim 22, wherein each shielding cup includes an attachment portion upstream of each nozzle portion, the attachment portion defining an opening adapted to receive the torch head therein, wherein each nozzle portion extends outward from the attachment portion and is in fluid communication therewith.
